(19) United States
(12) Patent Application Publication
(10) Pub. No.: US 2012/0089430 A1
(43) Pub. Date: Apr. 12, 2012

(54) DISTRIBUTED PROCESSING SYSTEM, OPERATION DEVICE, OPERATION CONTROL DEVICE, OPERATION CONTROL METHOD, METHOD OF CALCULATING COMPLETION PROBABILITY OF OPERATION TASK, AND PROGRAM

(76) Inventors: Masakazu Ukita, Kanagawa (JP); Atsushi Okamori, Tokyo (JP); Shiho Moriai, Kanagawa (JP); Masanobu Katagi, Kanagawa (JP)

(21) Appl. No.: 13/309,289

(22) Filed: Dec. 1, 2011

(30) Foreign Application Priority Data
Oct. 12, 2010 (JP) P2010-275975

(51) Int. Cl. G06Q 10/06; G06F 15/16

(52) U.S. Cl. 705/7.12; 709/226

(57) ABSTRACT

A distributed processing system includes a plurality of operation devices that perform an operation using power derived from natural energy; and an operation control device that includes a task assigning unit that assigns the same operation task to the plurality of operation devices, and an operation control unit that controls the plurality of operation devices to perform the operation task assigned by the task assigning unit.

### BACKGROUND

The present disclosure relates to a distributed processing system, an operation device, an operation control device, an operation control method, a method of calculating a completion probability of an operation task, and a program.

Finiteness of exhaustive energy such as oil and coal has been advocated, and a great deal of attention has been paid to power generation using natural energy such as solar energy and wind energy. For example, to replace power plants generating power using exhaustive energy, solar power plants using solar energy and wind power plants are being constructed at various locations. As concerns of general citizens about protection of the natural environment increase, power generation equipment such as solar power equipment has become widespread even to general homes. Attention may be paid to various methods of using natural energy, for example, a method (e.g., see Japanese Unexamined Patent Application Publication No. 2010-255963) of effectively using natural energy, and a method (e.g., see Japanese Unexamined Patent Application Publication No. 2010-119225) of effectively using power derived from natural energy.

### SUMMARY

However, the supply amount of natural energy changes according to weather conditions. For example, on a rainy day, the sunshine duration is short. On a calm day, the wind force is about 0. In such weather conditions, barely any power is able to be obtained from solar power generation or wind power generation. In this case, it is difficult to avoid interruption of operation of an electronic apparatus operated using the power derived from natural energy. Even when the operation is not completely interrupted, the supply amount of power is small, and thus it is considered that processing performance of the electronic apparatus may decrease. As described above, in an electronic apparatus operated using power derived from natural energy, the interruption of the operation or the decrease of the processing performance may occur at an unexpected timing.

For this reason, to use such an electronic apparatus, it is necessary to cause the electronic apparatus to perform the process by a method of reliably completing the process to be performed. Now, a system of realizing distributed computing using a plurality of operation devices operated using the power derived from natural energy is conceivable. As described in the electronic apparatus, in the operation devices included in the system, the interruption of the operation or the decrease of the processing performance may occur at an unexpected timing. For this reason, when the operation of the operation device is coincidentally interrupted or the decrease of the processing performance is requested for an operation task, it is difficult to complete the operation task within a predetermined period.

In a distributed processing system distributing and performing an operation task by a plurality of operation devices performing an operation using natural energy, it is desirable to provide a new and improved distributed processing system, operation device, operation control device, operation control method, method of calculating a completion probability of an operation task, and program, which are capable of obtaining an operation result with a high probability in a predetermined period.

According to an embodiment of the present disclosure, there is provided a distributed processing system including: a plurality of operation devices that perform an operation using power derived from natural energy; and an operation control device that includes a task assigning unit that assigns the same operation task to the plurality of operation devices, and an operation control unit that controls the plurality of operation devices to perform the operation task assigned by the task assigning unit.

Each operation device may include a probability calculating unit that calculates a probability of completing the operation task within a predetermined period on the basis of weather information. The task assigning unit may extract a combination of the operation devices in which the probability of completing the operation task within the predetermined period by at least one operation device is equal to or more than a predetermined value on the basis of the probability calculated by the probability calculating unit of each operation device, and may assign the operation task to the plurality of extracted operation devices.

The operation control device may further include a cost acquiring unit that acquires an amount of payable costs when the operation task is performed in the operation devices. When there are a plurality of combinations of the operation devices, the task assigning unit may select a combination of the operation devices in which the sum of costs acquired by the cost acquiring unit is the minimum, and may assign the operation task to the plurality of selected operation devices.

Each operation device may further include a probability calculating unit that calculates a probability of completing the operation task within a predetermined period on the basis of weather information. The operation control device may further include a cost acquiring unit that acquires an amount of payable costs when the operation task is performed in the operation devices. In this case, the task assigning unit may extract combinations in which the sum of costs acquired by the cost acquiring unit is equal to less then a predetermined amount, may select a combination of the operation devices in which the probability of completing the operation task within the predetermined period by at least one operation device is the minimum from the extracted combinations of the operation devices on the basis of the probability calculated by the probability calculating unit, and may assign the task to the plurality of selected operation devices.

The probability calculating unit may include a probability distribution calculating unit that is connected to the operation device and calculates a distribution p(Q) of probabilities of generating a power quantity Q within the predetermined period by a natural energy generator supplying the power derived from the natural energy to the operation device on the basis of the weather information, a power consumption calculating unit that calculates a power quantity Qc consumed when the operation device performs the operation task, and a power generation probability calculating unit that calculates a probability P of generating power equal to or more than the power quantity Qc calculated by the power consumption calculating unit by the natural energy generator within the predetermined period on the basis of the distribution p(Q) of the probabilities calculated by the probability distribution calculating unit. In this case, each operation device may report the probability P calculated by the power generation probability calculating unit to the operation control device, as the probability of completing the operation task within the predetermined period by the operation device.

When a storage battery with a storage quantity Qb is connected to the operation device, the power generation probability calculating unit may calculate a probability P of generating power equal to more than power quantity (Qc−Qb) obtained by subtracting the storage quantity Qb from the power quantity Qc by the natural energy generator within the predetermined period, on the basis of the distribution P(Q) of the probabilities calculated by the probability distribution calculating unit.

According to another embodiment of the present disclosure, there is provided an operation device including: a power receiving unit that receives power supplied from a generator generating power using natural energy; a task information acquiring unit that acquires information related to an operation task and information related to a completion limit of the operation task; a weather information acquiring unit that acquires weather information within a period until the completion limit of the operation task acquired by the task information acquiring unit; a distribution calculating unit that calculates probability distribution of the power quantity supplied to the power receiving unit within the period until the completion limit of the operation task on the basis of the weather information acquired by the weather information acquiring unit; a power consumption calculating unit calculates a power quantity necessary to perform the operation task on the basis of the information related to the operation task acquired by the task information acquiring unit; and a completion probability calculating unit that calculates a probability of completing the operation task within the period until the completion limit of the operation task on the basis of the probability distribution of the power quantity calculated by the distribution calculating unit and the power quantity calculated by the power consumption calculating unit.

According to still another embodiment of the present disclosure, there is provided an operation control unit including: a task assigning unit that assigns the same operation task to a plurality of operation devices performing an operation using power derived from natural energy; and an operation control unit that controls the plurality of operation devices to perform the operation task assigned by the task assigning unit.

According to still another embodiment of the present disclosure, there is provided an operation control method including: assigning the same operation task to a plurality of operation devices performing an operation using power derived from natural energy; and controlling the plurality of operation devices to perform the operation task assigned by the task assigning unit.

According to still another embodiment of the present disclosure, there is provided a method of calculating a completion probability of an operation task in an operation device having a power receiving unit receiving power supplied from a power generator generating power using natural energy, the method including: acquiring information related to an operation task and information related to a completion limit of the operation task; acquiring weather information within the period until the completion limit of the operation task acquired in the acquiring of the task information; calculating probability distribution of the power quantity supplied to the power receiving unit within the period until the completion limit of the operation task on the basis of the weather information acquired in the acquiring of the weather information; calculating a power quantity necessary to perform the operation task on the basis of the information related to the operation task acquired in the acquiring of the task information; and calculating a probability of completing the operation task within the period until the completion limit of the operation task on the basis of the probability distribution of the power quantity calculated in the calculating of the distribution and the power quantity calculated in the calculating of the power consumption.

According to still another embodiment of the present disclosure, there is provided a program for causing a computer to execute: a task assigning a function of assigning the same operation task to a plurality of operation devices performing an operation using power derived from natural energy; and an operation control function of controlling the plurality of operation devices to perform the operation task assigned by the task assigning function.

According to still another embodiment of the present disclosure, there is provided a program for causing a computer having a power receiving unit that receives power supplied from a generator generating power using natural energy to execute: a task information acquiring function of acquiring information related to an operation task and information related to a completion limit of the operation task; a weather information acquiring function of acquiring weather information within the period until the completion limit of the operation task acquired by the task information acquiring function; a distribution calculating function of calculating probability distribution of the power quantity supplied to the power receiving unit within the period until the completion limit of the operation task on the basis of the weather information acquired by the weather information acquiring function; a power consumption calculating function of calculating a power quantity necessary to perform the operation task on the basis of the information related to the operation task acquired by the task information acquiring function; and a completion probability calculating function of calculating a probability of completing the operation task within the period until the completion limit of the operation task on the basis of the probability distribution of the power quantity calculated by the distribution calculating function and the power quantity calculated by the power consumption calculating function.

According to still another embodiment of the present disclosure, there is provided a recording medium in which the program is recorded, which is readable by a computer.

As described above, according to the embodiments of the present disclosure, in the distributed processing system distributing and performing the operation task by the plurality of operation devices performing the operation using natural energy, it is possible to obtain the operation result with the high probability within the predetermined period.

### BRIEF DESCRIPTION OF THE DRAWINGS

FIG. 1 is a diagram illustrating an example of a system configuration of a distributed processing system according to an embodiment of the present disclosure.

FIG. 2 is a diagram illustrating a method of assigning an operation task according to the embodiment of the present disclosure.

FIG. 3 is a diagram illustrating a functional configuration of an operation control device included in the distributed processing system according to the embodiment of the present disclosure.

FIG. 4 is a diagram illustrating a functional configuration of an operation device included in the distributed processing system according to the embodiment of the present disclosure.

FIG. 5 is a diagram illustrating a diagram illustrating an operation control method according to the embodiment of the present disclosure.

FIG. 6 is a diagram illustrating a method of calculating an operation completion probability according to the embodiment of the present disclosure.

FIG. 7 is a diagram illustrating a method of calculating an operation completion probability according to the embodiment of the present disclosure.

FIG. 8 is a diagram illustrating a method of calculating an operation completion probability according to the embodiment of the present disclosure.

FIG. 9 is a diagram illustrating a method of assigning an operation task (a method of selecting an operation device) according to the embodiment of the present disclosure.

FIG. 10 is a diagram specifically illustrating the method of assigning the operation task (the method of selecting the operation device) according to the embodiment of the present disclosure.

FIG. 11 is a diagram illustrating an operation control method according to a modified example of the embodiment of the present disclosure.

FIG. 12 is a diagram illustrating a method of assigning operation task (a method of selecting an operation device) according to the modified example of the embodiment of the present disclosure.

FIG. 13 is a diagram illustrating a hardware configuration of an information processing device capable of realizing the functions of the operation control device and the operation device according to the embodiment of the present disclosure.

### DETAILED DESCRIPTION OF EMBODIMENTS

Hereinafter, preferred embodiments of the present disclosure will be described in detail with reference to the accompanying drawings. In the specification and the drawings, the same reference numerals and signs are given to constituent elements having substantially the same functional configuration, and the repeated description is omitted.

Flow of Description

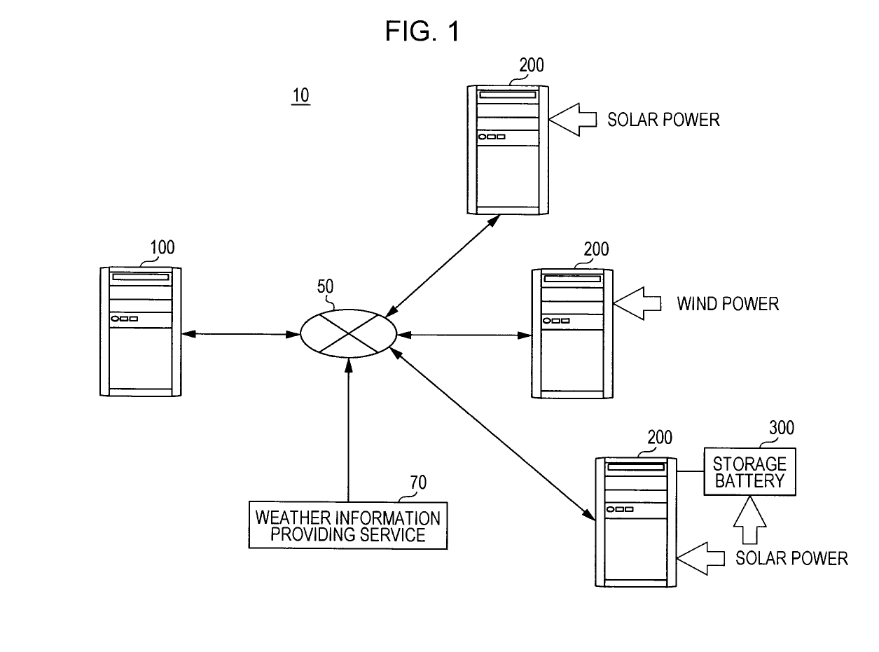

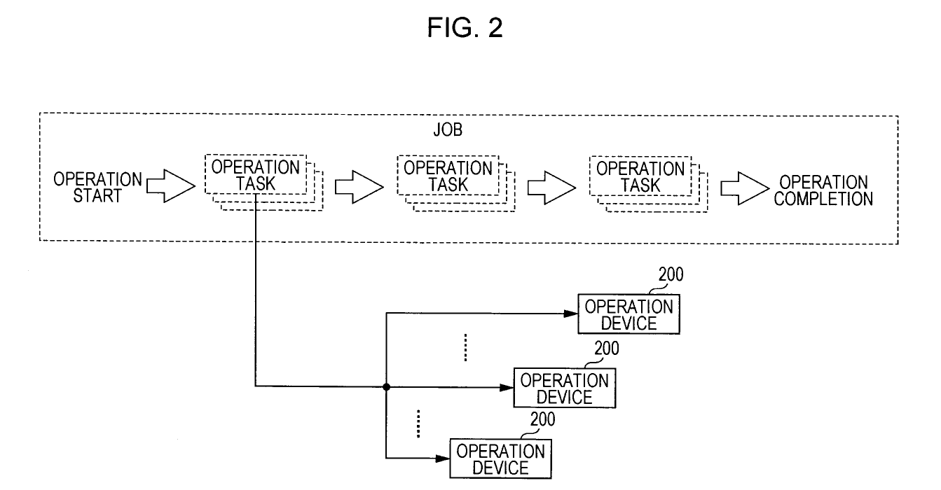

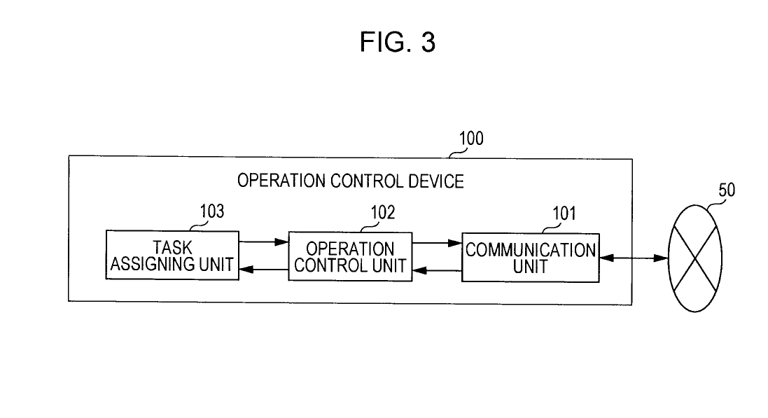

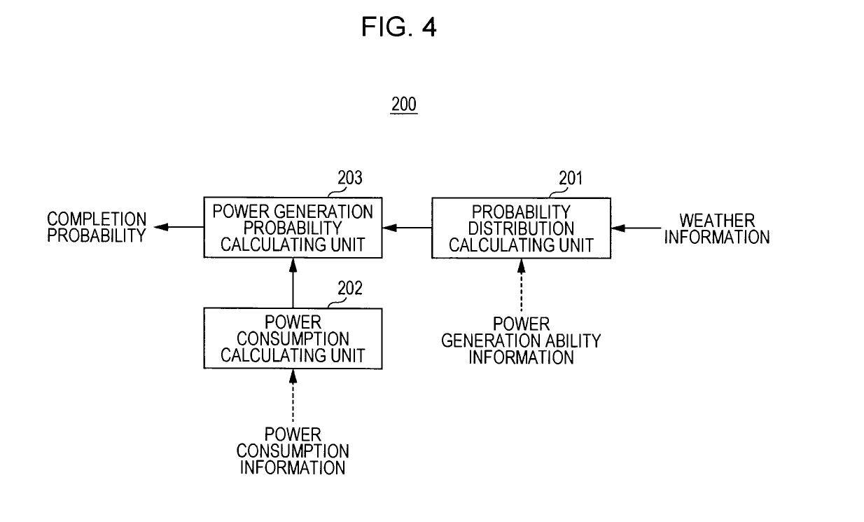

The flow of the description according to the embodiments of the present disclosure will be briefly described herein. First, an example of a system configuration of a distributed processing system 10 according to the embodiment will be described with reference to FIG. 1. Next, a method of assigning an operation task according to the embodiment will be described with reference to FIG. 2. Next, a functional configuration of an operation control device 100 included in the distributed processing system 10 according to the embodiment will be described with reference to FIG. 3. Next, a functional configuration of an operation device 200 included in the distributed processing system 10 according to the embodiment will be described with reference to FIG. 4.

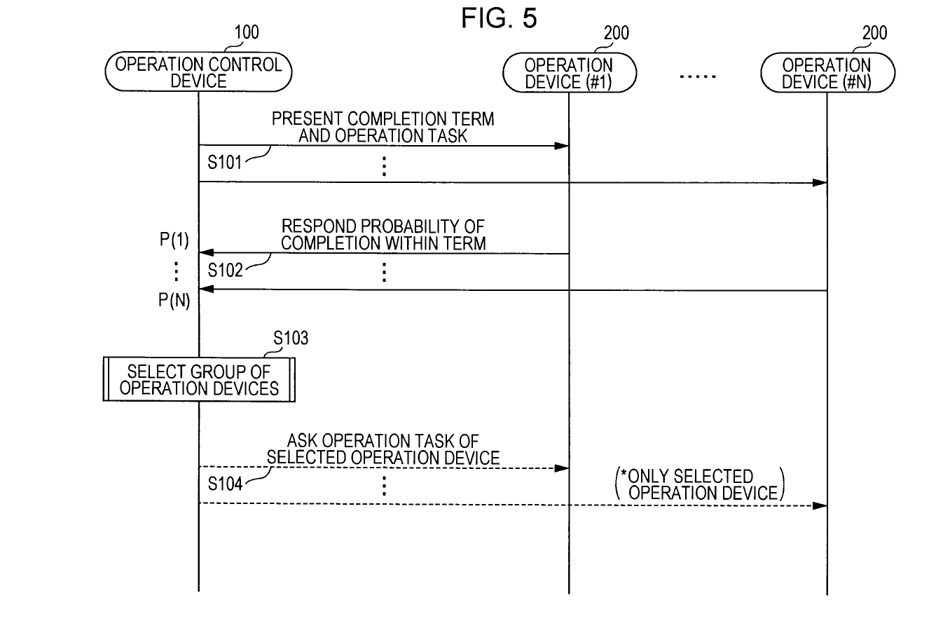

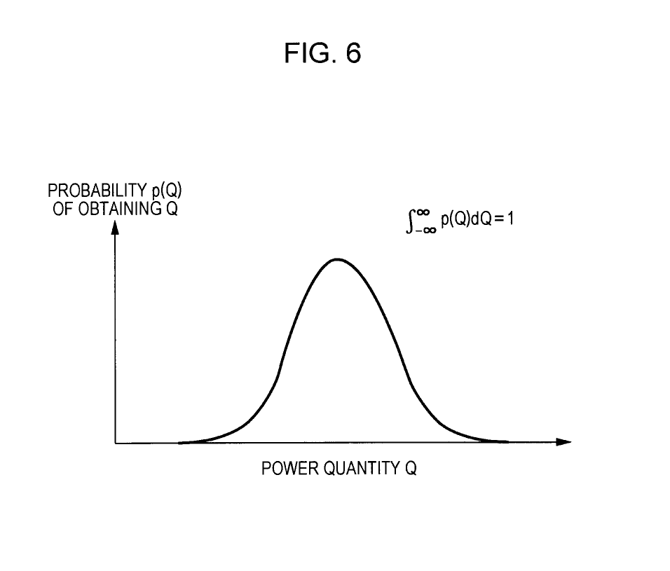

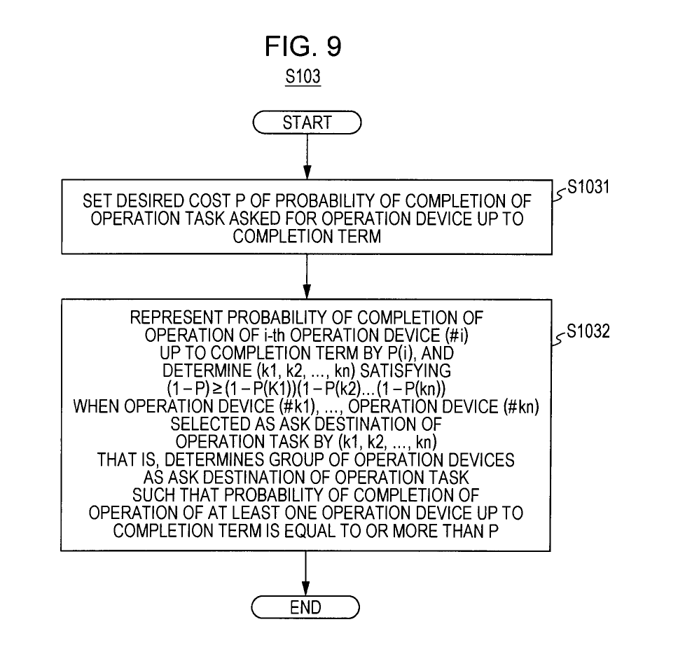

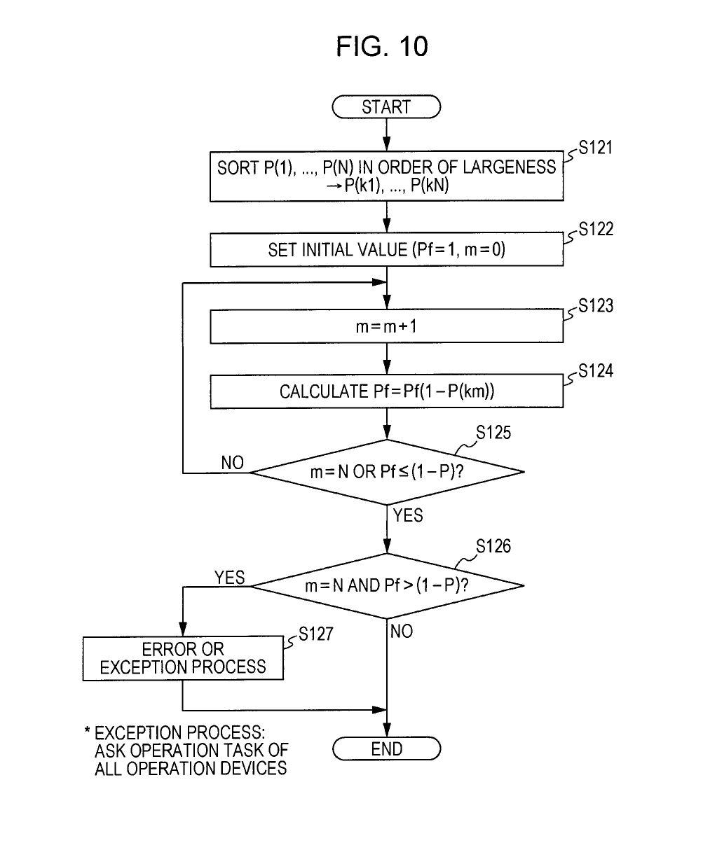

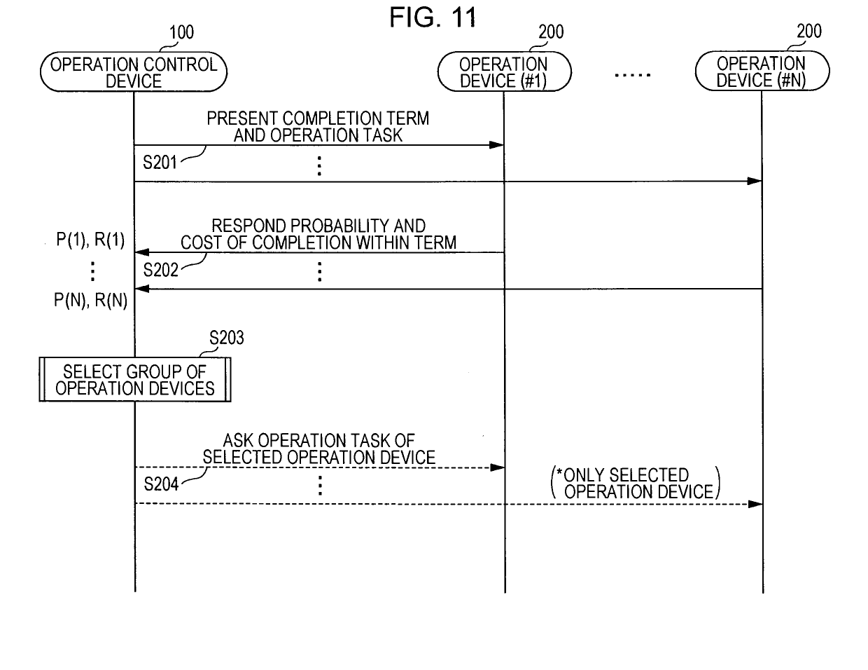

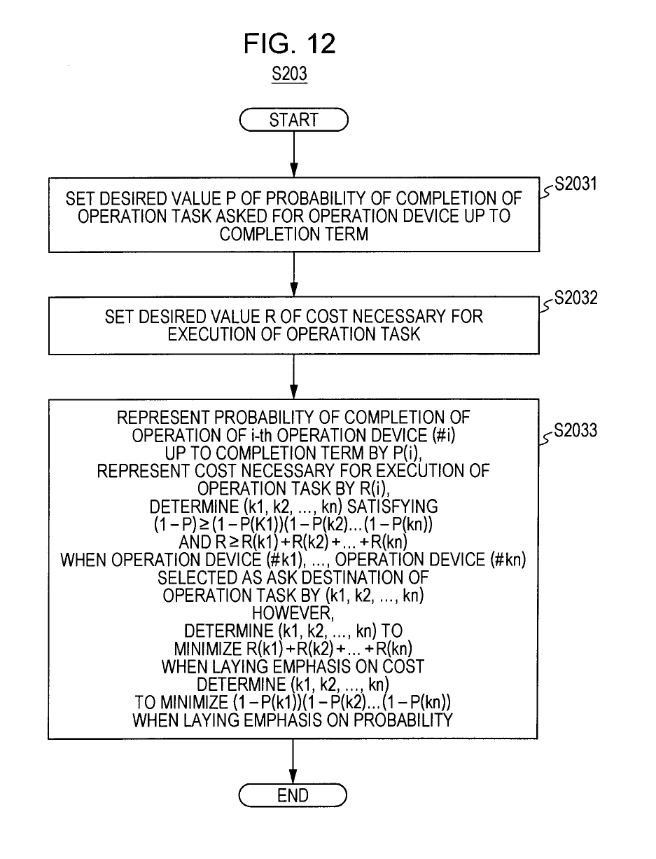

Next, an operation control method according to the embodiment will be described with reference to FIG. 5. A method of calculating an operation completion probability according to the embodiment will be described with reference to FIG. 6 to FIG. 8. Next, a method of assigning an operation task (a method of selecting the operation device 200) according to the embodiment will be described with reference to FIG. 9 and FIG. 10. Next, an operation control method according to a modified example of the embodiment will be described with reference to FIG. 11. A method of assigning an operation task (a method of selecting the operation device 200) according to a modified example of the embodiment will be described with reference to FIG. 12.

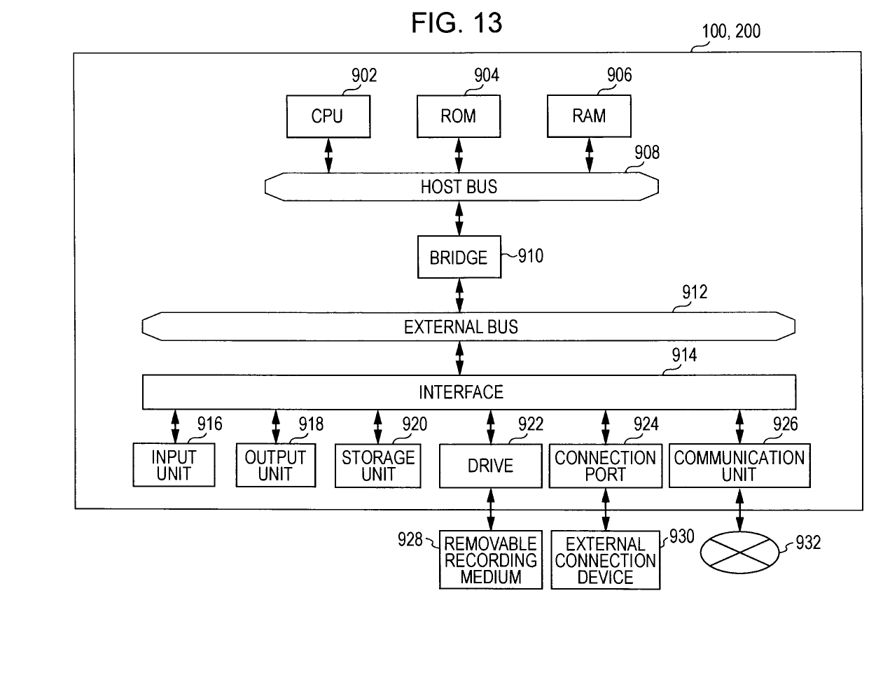

A hardware configuration of an information processing device capable of realizing the functions of the operation control device 100 and the operation device 200 according to the embodiment will be described with reference to FIG. 13. Finally, in regards to the technical concept of the embodiment, the operational effects obtained from the technical concept will be briefly described.

### DESCRIPTION INDEX

1: Embodiment

1-1: System Configuration of Distributed Processing System 10

1-1-1: Overall Configuration

1-1-2: Method of Assigning Operation Task

1-1-3: Functional Configuration of Operation Control Device 100

1-1-4: Functional Configuration of Operation Device 200

1-2: Operation Control Method

1-2-1: Overall Configuration

1-2-2: Method of Calculating Completion Probability

1-2-3: Method of Assigning Operation Task (Method of Selecting Operation Device 200)

2: Modified Example

2-2: Operation Control Method

2-2-1: Overall Configuration

2-2-2: Method of Assigning Operation Task (Method of Selecting Operation Device 200)

3: Example of Hardware Configuration

4: Conclusion

1: Embodiment

An embodiment of the present disclosure will be described.

1-1: Configuration of Distributed Processing System 10

Hereinafter, a configuration of a distributed processing system 10 according to the embodiment will be described in detail.

1-1-1: Overall Configuration

First, an overall configuration of the distributed processing system 10 according to the embodiment will be described with reference to FIG. 1. FIG. 1 is a diagram illustrating the overall configuration of the distributed processing system 10 according to the embodiment.

As shown in FIG. 1, the distributed processing system 10 includes an operation control device 100 and a plurality of operation devices 200. The operation control device 100 and the plurality of operation devices 200 are connected to each other through a network 50. The network 50 is connected to a provider of a weather information providing service 70. In the example shown in FIG. 1, the number of operation device 200 is three, but the number of operation devices 200 may be two, four, or more.

The distributed processing system 10 assigns the same operation task to the plurality of operation devices 200, and controls the plurality of operation devices 200 to perform the same operation task in parallel. The operation control device 100 performs the process of assigning the operation task. The operation device 200 according to the embodiment operates using power derived from natural energy. For example, the operation device 200 operates using power generated by solar power generation or wind power generation. The operation device 200 may be connected to a storage battery 300. In this case, the operation 200 operates using power stored in the storage 300 and power derived from natural energy.

Generally, the distributed processing technique of causing a plurality of computers to distribute and perform a plurality of operation tasks is used in various kinds of fields. For example, the distributed processing technique is used in large-scale calculation such as calculation of molecular dynamics or calculation of weather forecasts. Particularly, great attention is paid to a technique called grid computing of performing the operation task in parallel using computers installed at a plurality of positions. However, a large amount of power is necessary to operate the plurality of computers. In a data center or the like in which high-performance computers are integrated, large-scale air conditioning equipment for cooling the computers is operating, and there is a considerable difference in power consumed to perform a certain operation.

For this reason, considering an influence on global warming, it is preferable that the power consumed to perform the certain operation be supplied from natural energy, and the consumption of exhaustive energy be suppressed to suppress the discharge of greenhouse effect gas as much as possible. That is, it can be said that a problem of modern living is to realize the large-scale calculation of “earth friendliness” in computers operated using the power derived from natural energy. For such a reason, the distributed processing system 10 according to the embodiment is designed. However, the supply amount of the power derived from natural energy is unstable. For example, the supply amount of power obtained by solar power generation depends on a sunshine condition.

For this reason, when using natural energy, a special task assigning method different from the task assigning method used by the general distributed computing is necessary. To ease the unstable power supply amount, it is preferable to consider the disposition of positions for installing the computers. For example, when all the computers are installed at the same position, all the computers may be stopped when the weather condition of the position becomes poor. To reduce such a risk, it is preferable to dispose the computers which carry out distributed processing at a geographically separated position.

Even with a design such as this, the operation is interrupted when the weather conditions become unexpectedly poor at the position where the computer assigning the operation task is installed, or when the operation task is assigned to the computer at the position where the weather conditions are coincidentally poor. In the case of general distributed computing, when a portion of operation tasks is not completed, it is difficult to obtain the final operation result. For this reason, when a portion of operation tasks is not completed, a process of assigning the uncompleted operation task to another computer again or waiting for the completion of the operation task by allowing delay occurs. As a result, performance of the entire system significantly decreases.

To avoid such a situation, the power stored in a mass-storage battery unit is subsidiarily used, or the power supplied from a power company is subsidiarily used, to operate the computer. However, when employing such a method, extra costs such as a cost for installing a storage battery unit and a cost for supplying power from a power company is consumed. When such extra costs are consumed, an operation cost per unit of calculation amount is reduced. For this reason, it is preferable to suppress generation of the extra cost as much as possible.

Considering such a circumstance, the inventors of the present disclosure designed a method of reducing a risk that the operation task is not completed within a desired period by causing the plurality of operation devices 200 to perform the same operation task. In addition, the inventors designed a structure in which at least one operation device 200 can complete the operation task within a desired limit at a desired probability. The distributed processing system 10 shown in FIG. 1 is an example thereof. In the distributed processing system 10, a unit requesting the operation task is the operation control device 100. A unit performing the operation task is the operation device 200.

As shown in FIG. 1, the operation device 200 may be connected to a storage unit (a storage battery 300). In this case, the cost of installing the storage battery 300 is necessary, but surplus power stored in the storage battery 300 is used in the case of a power shortage, and thus it is possible to stabilize the power supply.

Hereinbefore the overall configuration of the distributed processing system 10 has been described.

1-1-2: Method of Assigning Operation Task

Next, the method of assigning the operation task according to the embodiment will be described with reference to FIG. 2. FIG. 2 is a diagram illustrating the method of assigning the operation according to the embodiment.

In the general distributed processing system, a process of dividing one operation unit called a job into a plurality of operation tasks and distributing the plurality of operation tasks to the plurality of operation devices is performed. A process of integrating the operation results of the operation tasks obtained by the operation devices and outputting the operation result of the original job is performed. The job is described in a predetermined program language. In the job, the method of dividing into the operation task may be described. The plurality of operation tasks related to each other may be integrally referred to as a job. As described above, one job is divided into the plurality of operation tasks and is performed in parallel in the plurality of operation devices, and thus it is possible to shorten the operation time. In addition, it is possible to perform a large-scale job within a practical time with a low cost by integrating the operation devices with low operation performance.

In the general distributed processing system, the process described above is performed. However, in the distributed processing system 10 according to the embodiment, as shown in FIG. 2, the same operation can be assigned to the plurality of operation devices 200, and the plurality of operation devices 200 perform the same operation task in parallel. Accordingly, the distributed processing system 10 is different in purpose from the general distributed processing system. As described above, the main purpose of the general distributed processing system is distribution of operation load. Meanwhile, the main purpose of the distributed processing system 10 is distribution of risk. That is, the main purpose of the distributed processing system 10 is to reduce the risk that the operation devices 200 do not complete the operation task within the predetermined period by assigning the same operation task to the plurality of operation devices 200.

In the general distributed processing system, generally, it is expected for the operation devices to reliably complete the operation task within a predetermined period. Particularly, when a manager of the distributed processing system manages operation circumstances of the operation devices and it is expected that the normal state where an obstacle does not occur is kept, it is not assumed that the operation task is not completed within the predetermined period. Even when a requestor of the operation task and a manger of the operation devices requested for the operation task are different, the requestor of the operation task will expect that the operation task is completed within the predetermined period by the operation device. In other words, in the general distributed processing system, it is natural that the completion of the operation task within the predetermined period by the operation devices is considered as a duty of the manager of the operation devices.

In regards to the manager of the operation device, when the operation is requested with an engagement of completing the operation task within a predetermined period in a probability of X % (X<100%) by the operation device, it is conceivable that the cost of the operation is reduced. For example, to complete the operation task within a predetermined period at a probability of 100%, it is necessary to avoid a defect of the operation device and a decrease of the operation from occurring during the operation. For this reason, the manager contracted for the operation with such an engagement may ask for payment which may be a great cost for maintenance of the operation device or environment maintenance. If the condition of the engagement can be eased, it is expected that it is possible to reduce the cost necessary for the maintenance of the operation device or the environment maintenance. As a result, it is thought that the cost necessary for the operation may be reduced by the easement of the engaged condition.

Considering a case of performing one operation task within one minute. For example, it is assumed that there is an operation device capable of completing the operation task within one minute at a probability of 50%. In this case, to complete the operation task within one minute at a probability equal to or higher than 90%, it is preferable to use four operation devices. The probability of not completing the operation task within one minute in all four operation devices is 0.5̂4=0.0625<0.1 (10%). For this reason, when the same operation task is performed in four operation devices, at least one operation device can complete the operation task within one minute at a probability equal to or higher than 90%. In this case, when the cost of the operation of the operation devices is equal to or less than ¼ due to the easiness of the condition, it is possible to reduce the total cost by requesting four operation devices for the same operation task. As described above, the method of assigning the same operation task to the plurality of operation devices includes possibility of reducing the cost necessary for the operation.

As described above, the distributed processing system 10 according to the embodiment assigns the same operation task to the plurality of operation devices 200 to perform the operation task in parallel. With such a configuration, the risk that the individual operation device 200 does not complete the operation task within the predetermined period is reduced. In addition, it is possible to decrease the reliability (probability of completion) expected for the individual operation device 200, and thus it is possible to reduce the total cost necessary for the operation as the case may be. However, the reliability regarding the operation and the cost regarding the operation are different according to the individual operation device 200. In addition, the reliability regarding the operation is different according to the period of performing the operation. For this reason, it is necessary to carefully determine the combination of the operation devices 200 to which the operation task has to be assigned.

Hereinafter, a task assigning method (a method of selecting the operation device 200) capable of appropriately determining the combination of the operation devices 200 to which the operation task has to be assigned, and a configuration of the operation control device 100 will be described. In addition, a configuration of the operation device 200 according to the embodiment will be described.

1-1-3: Functional Configuration of Operation Control Device 100

Next, a functional configuration of the operation control device 100 according to the embodiment will be described with reference to FIG. 3. FIG. 3 is a diagram illustrating a functional configuration of the operation control device 100 according to the embodiment.

As shown in FIG. 3, the operation control device 100 mainly includes a communication unit 101, an operation control unit 102, and a task assigning unit 103. The communication unit 101 is a communication unit for performing communication through the network 50.

When the operation device 200 is requested for any operation task, the operation control unit 102 transmits information (hereinafter, referred to as completion limit information) representing the operation task and the completion limit to the operation device 200 through the communication unit 101. The operation control unit 102 may transmit information representing the amount of operations of the operation task instead of the operation task. The completion limit described herein is a time limit to complete the operation task. The operation control unit 102 may transmit information representing an execution start time (the timing when the operation device 200 is actually requested for the operation task) of the operation task, and the information representing the completion period, together. However, hereinafter, in the following description, the operation control unit 102 transmits the operation task and the completion limit information to the operation device 200.

The operation device 200 receiving the operation task and the completion limit information reports the probability (hereinafter, referred to as a completion probability) of completing the operation task to the completion limit, to the operation control device 100. When the completion probabilities are reported from the plurality of operation devices 200 to the operation control device 100, the information (hereinafter, referred to as completion probability information) representing the completion probability is input to the task assigning unit 103. The operation device 200 receiving the operation task and the completion limit reports an amount of costs regarding the execution of the operation task (hereinafter, referred to as operation cost amount) to the operation control device 100. When the operation cost amounts are reported from the plurality of operation devices 200 to the operation control device 100, the information (hereinafter, referred to as cost amount information) representing the operation cost amount is input to the task assigning unit 103.

When the completion probability and the cost amount information are input, the task assigning unit 103 selects a combination of the operation devices 200 in which at least one operation device 200 can complete the operation task to the completion limit (hereinafter, referred to as an entire completion probability) is equal to or more than a predetermined value and the sum of the operation cost amounts (hereinafter, referred to as a sum cost amount) is equal to or less than a predetermined amount. For example, the task assigning unit 103 extracts combinations of the operation devices 200 in which the entire completion probability is equal to or lower than a predetermined value, and selects a combination in which the sum cost amount is the minimum is selected from the extracted combinations. The task assigning unit 103 may extract combinations of the operation devices 200 in which the sum cost amount is equal to row less than a predetermined amount, and may select a combination in which the entire completion probability is the maximum from the extracted combinations.

When the combination of the operation devices 200 requested for the operation task is selected, the task assigning unit 103 assigns the operation task to the selected operation device 200. The task assigning unit 103 inputs the information of the operation device 200 to which the operation task is assigned, to the operation control unit 102. When the information of the operation device 200 to which the operation task is assigned is input, the operation control unit 102 requests the operation device 200 to which the operation task is assigned through the communication unit 101, to perform the operation task on the basis of the input information. When the operation task is not transmitted to the operation device 200, the operation control unit 102 transmits the operation task to the operation device 200 in this step. The operation device 200 requested for the operation task performs the operation task according to the request, and transmits the operation result to the operation control device 100.

The functional configuration of the operation control device 100 has been described above. Herein, a configuration of selecting the combination of the operation devices 200 to be requested for the operation task on the basis of the completion probability reported from the operation devices 200 and the operation cost amount has been described. However, the operation control device 100 may be configured to select the combination of the operation devices 200 requested for the operation task without considering the operation cost amount. In this case, the function of the task assigning unit 103 is more simplified. In this case, the operation 200 does not transmit the cost amount information, and completes the process.

1-1-4: Functional Configuration of Operation Device 200

Next, a functional configuration of the operation device 200 according to the embodiment will be described with reference to FIG. 4. FIG. 4 is a diagram illustrating the functional configuration of the operation device 200 according to the embodiment. Herein, a function of calculating the completion probability will be mainly described.

As shown in FIG. 4, the operation device 200 mainly includes a probability distribution calculating unit 201, a power consumption calculating unit 202, and a power generation probability calculating unit 203. Although not shown in FIG. 4, the operation device 200 has a power receiving unit receiving power supplied from a power generator generating power using natural energy, a communication unit for communicating through the network 50, and an operation unit performing the operation task.

Power generation ability information representing power generation ability of the power generator is input to the probability distribution calculation unit 201. Operation ability information representing operation ability (e.g., an operation clock frequency, etc.) of the operation unit, and power consumption information representing the power quantity consumed when the operation per unit of the amount of operations are input to the power consumption calculating unit 202. The completion limit information transmitted from the operation control device 100 is input to the probability distribution calculating unit 201 and the probability calculating unit 203. The operation task (or information representing the amount of operations of the operation task) transmitted from the operation control device 100 is input to the power consumption calculating unit 202.

As described above, before the requesting of the operation task, the operation control device 100 transmits the operation task (or information representing the amount of operations of the operation task) and the completion limit information to the operation devices 200, and requests the operation devices 200 for the completion probability. When receiving the request, the operation device 200 acquires the weather information from, for example, a weather information providing service 70 (see FIG. 1) through the network 50. The weather information is input to the probability distribution calculating unit 201. As described above, the power generation ability information and the completion limit information are input to the probability distribution calculating unit 201. When such information is input, the probability distribution calculating unit 201 calculates a probability distribution p(Q) (see FIG. 6) of the power generation quantity Q during the period on the basis of the weather information in the period until the completion limit.

The information of the probability distribution p(Q) calculated by the probability distribution calculating unit 201 is input to the power generation probability calculating unit 203. The operation task and power consumption information are input to the power consumption calculating unit 202. When the operation task is performed, the power consumption calculating unit 202 calculates a power quantity Qtask consumed by the operation unit. The information of the power quantity Qtask calculated by the power consumption calculating unit 202 is input to the power generation probability calculating unit 203. When the information of the probability distribution p(Q) and the information of the power quantity Qtask are input, the power generation probability calculating unit 203 calculates a probability P that power equal to or larger than the power quantity Qtask to the completion limit using the probability distribution p(Q). The power generation probability calculating unit 203 transmits the calculated probability P as the completion probability to the operation control device 100.

The functional configuration of the operation device 200 has been described above. Herein, although a unit of calculating the operation cost amount is not described, the operation device 200 may be provided with the unit of calculating the operation cost amount according to the operation task. In this case, the calculating unit calculates the operation cost amount corresponding to the amount of operations of the operation task or the like, and reports the operation cost amount to the operation control device 100.

1-2: Operation Control Method

Next, the operation control method according to the embodiment will be described with reference to FIG. 5 to FIG. 10. Herein, the method of calculating the completion probability and the method of assigning the operation task (the method of selecting the operation device 200) will be described in more detail.

1-2-1: Overall Configuration

First, an overall flow of the process according to the operation control method of the embodiment will be described with reference to FIG. 5. FIG. 5 is a diagram illustrating the overall flow of the process according to the operation control method of the embodiment. Herein, a case of not considering the operation cost amount when selecting the combination of the operation devices 200 to be requested for the operation task will be described.

As shown in FIG. 5, first, the operation control device 100 presents the completion limit and the operation task to the plurality of operation devices 200 (#1 to #N) by the function of the operation control unit 102 (S101). The operation device 200 receiving the completion limit and the operation task calculates the completion probability, and transmits the information of the calculated completion probability to the operation control device 100 (S102). The operation control device 100 receiving the information of the completion probabilities P(1) to P(N) from the plurality of operation devices 200 (#1 to #N) selects a combination of the operation devices 200 in which the probability (the entire completion probability) of completing the operation task to the completion limit by at least one operation device 200 is equal to or more than a predetermined value by the task assigning unit 103 (S103), and assigns the operation task to the selected operation device 200. Then, the operation control device 100 requests the operation device 200 assigning the operation task, for the operation task by the function of the operation control unit 102 (S104).

The overall flow of the process according to the operation control method of the embodiment has been described above.

1-2-2: Method of Calculating Completion Probability

Next, the method of calculating the completion probability according to the embodiment will be described in detail with reference to FIG. 6 to FIG. 8. FIG. 6 to FIG. 8 are diagrams specifically illustrating the method of calculating the completion probability according to the embodiment. The method of calculating the completion probability described herein is realized by the function of the operation device 200. However, when to the operation control device 100 can acquire the information necessary for the calculation of the completion probability such as the power generation ability information and the power consumption information, the distributed processing system 10 may be configured to calculate the completion probability in the operation control device 100.

Method of Calculating Probability Distribution p (Q)

First, description will be performed with reference to FIG. 6. In FIG. 6, an example of the probability distribution p(Q) obtaining the power quantity Q (the power quantity Q substantially usable by the operation device 200) from the power generator to the completion limit is shown. The probability distribution p(Q) may be estimated from the weather information and the like during the period of the completion limit by the function of the probability distribution calculating unit 201. For example, when the solar power generator is used, it is possible to acquire the power generation quantity in a time band using the power generation ability information on the basis of the sunshine condition (the sunshine time of the region where the operation device 200 is installed) in the time band expected to perform the operation task. However, the weather information (weather forecast) at the future time point is given as information of the probability distribution calculated on the basis of a season, a date, a time, and a sunshine condition and the like at the present time point. For this reason, the power generation quantity in the time band of execution of the operation task can be only probabilistically obtained.

As described above, it is possible to obtain the probability distribution p(Q) regarding the power generation quantity Q in the time band of execution of the operation task on the basis of the weather information. That is, it is possible to obtain the probability distribution p(Q) regarding the power quantity Q shown in FIG. 6. Data such as the past weather information, weather forecasting, and power generation quantity may be stored, and the probability distribution p(Q) regarding the power generation quantity Q may be calculated from the present weather information and weather forecasting, using data mining. When the storage battery 300 is connected to the operation device 200, the storage power quantity Qb (usable in the operation device 200 in the time band of execution of the operation task) of the storage battery 300 can be supplied to the operation device 200 at a probability of 100%. For this reason, when the storage battery 300 is connected to the operation device 200, the probability distribution p(Q) shown in FIG. 6 is shifted to the right side by the storage power quantity Qb.

Method of Calculating Power Consumption Quantity Qtask

Next, the method of calculating the power quantity Qtask consumed by the operation device 200 when the operation task is performed will be described. The method of calculating the power consumption quantity Qtask described herein is realized by the function of the power consumption calculating unit 202. The operation device 200 has a function of changing an operation clock frequency f and an operation voltage V. The power consumption quantity Qtask gets smaller as the operation clock frequency f gets lower. The power consumption quantity Qtask gets smaller as the operation voltage V gets lower. When the operation clock frequency f gets lower, the operation voltage V gets lower. That is, when the operation clock frequency f becomes a half, the operation voltage V gets lower, and thus the power consumption quantity Qtask gets smaller than the half.

When the operation clock frequency f gets lower, the amount of performable operations per unit of time gets smaller. However, as the operation clock frequency gets lower, the amount of performable operations per unit of power consumption quantity gets larger. To complete the operation task until a predetermined limit, when the operation is performed at a low operation clock frequency f of completing the operation task tightly within the predetermined limit, it is thought that it is possible to complete the operation task with a small power consumption quantity Qtask. That is, even when the power generation quantity Q generated by the generator is small and when the operation clock frequency f is suppressed to be lower, it is thought that the probability of completing the operation task to a predetermined limit gets higher. For such a reason, it is preferable that the operation device 200 is configured to operate at the minimum operation clock frequency f of completing the operation task until the predetermined limit.

A method of calculating the minimum operation clock frequency f of completing the operation task until the predetermined limit and a method of calculating the power consumption quantity Qtask will be described.

First, when the operation task is given, the power consumption calculating unit 202 calculates the amount of operations (the number of cycles c to perform) of the operation task. Then, the power consumption calculating unit 202 removes the number of cycles c in a period T (a period from the execution start time of the operation task to the completion limit) until a predetermined limit, and calculates the operation clock frequency f0 (f0=c/T) that is a target. Then, the power consumption calculating unit 202 selects the operation clock frequency f that is the minimum in the range of f≧f0, in the variable range of the operation clock frequency f. However, when there is no operation clock frequency f of f≧f0 in the variable range of the operation clock frequency f, the operation device 200 does not complete the operation task until the predetermined limit. In this case, the completion probability P is 0.

When the operation clock frequency f is selected, the power consumption calculating unit 202 calculates the power quantity Qtask consumed when operating at the operation clock frequency f until the predetermined limit on the basis of the power consumption information. For example, when the power quantity consumed per unit of time is Pw(f) in the case of operating at the operation clock frequency f, the power consumption calculating unit 202 calculates the power consumption quantity Qtask=Pw(f)*T during the period T from Pw(f). When the operation clock frequency f is fixed, the power consumption quantity Qtask=Pw*T is calculated using the fixed power quantity Pw consumed per unit of time and the period T.

Method of Calculating Completion Probability P

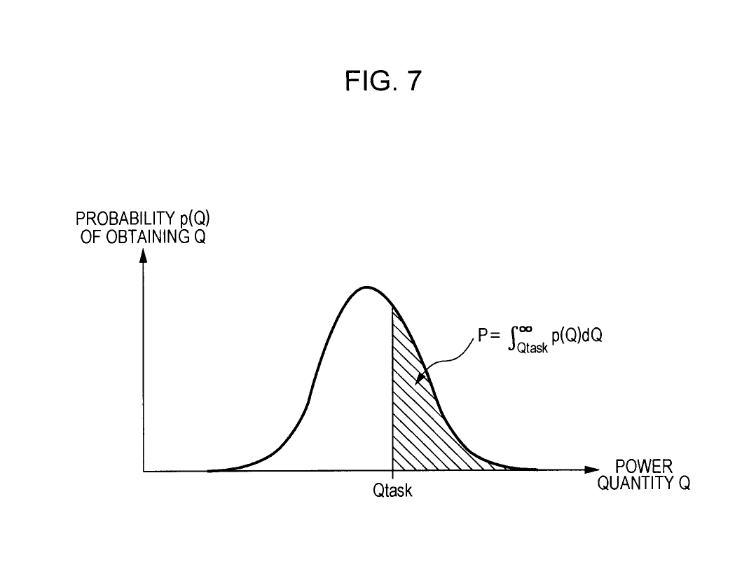

Next, description will be performed with reference to FIG. 7. In FIG. 7, the method of calculating the completion probability P using the probability distribution p(Q) and the power consumption quantity Qtask is shown. The completion probability P represents a probability of completing the operation task until the completion limit. The condition of completing the operation task until the completion limit is that the power equal to or more than the power consumption quantity Qtask necessary to perform the operation task is supplied to the operation device 200. That is, it can be said that the completion probability P is a probability of supplying the power equal to or more than the power consumption quantity Qtask to the operation device 200. The power generation probability calculating unit 203 performs integration (corresponding to an area of the oblique line portion shown in FIG. 7) shown in the following formula (1) to calculate the completion probability P. When it is possible to only probably acquire the power consumption quantity Qtask, the completion probability P is calculated by the following formula (2) using the probability distribution p′(Qtask) of the power consumption quantity Qtask.

P=∫_{Q}_{ₜₐₛₖ}^{∞}p(Q)dQ (1)

P=∫₀^{∞}p′(Qₜₐₛₖ)dQₜₐₛₖ ∫_{Q}_{ₜₐₛₖ}^{∞}p(Q)dQ (2)

Flow of Process

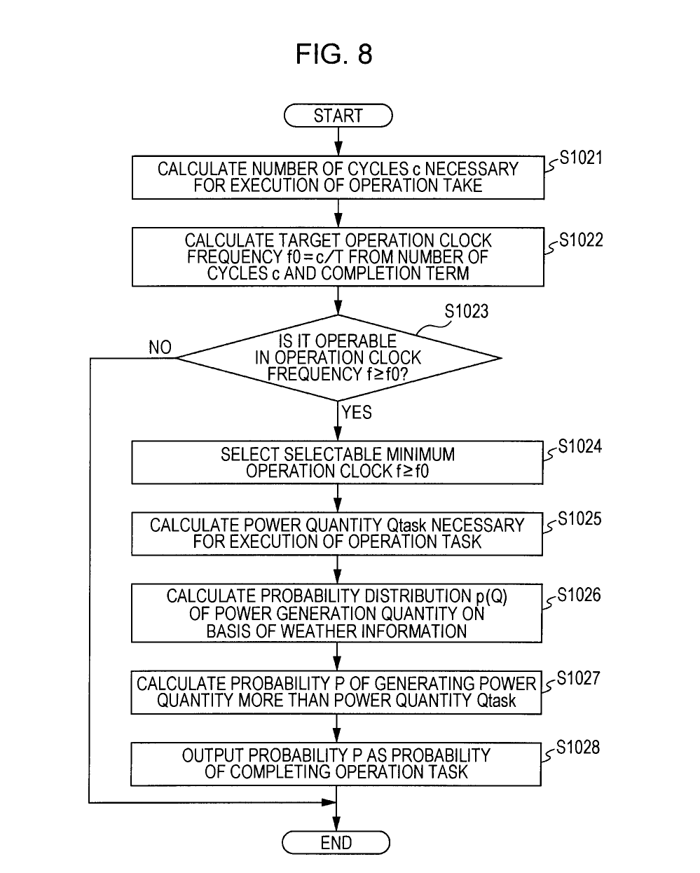

The flow of the process according to the calculation of the completion probability P will be described with reference to FIG. 8. FIG. 8 is a diagram illustrating the flow of the process according to the calculation of the completion probability P. In the process steps shown in FIG. 8, the process of Step S1026 may be moved to the front end of Step S1021 or between Steps S1021 to S1026.

As shown in FIG. 8, first, the operation device 200 calculates the number of cycles c necessary to perform the operation task by the function of the power consumption calculating unit 202 (S1021). Then, the operation device 200 calculates the operation clock frequency f0=c/T that is the target from the number of cycles c and the period T to the completion limit by the function of the power consumption calculating unit 202 (S1022). Then, the operation device 200 determines whether or not it is possible to operate at the operation clock frequency f satisfying the condition of f≧f0 by the function of the power consumption calculating unit 202 (S1023). When it is possible to operate at the operation clock frequency f satisfying the condition of f≧f0, the operation device 200 transfers the process to Step S1024. When it is difficult to operate at the operation clock frequency f satisfying the condition of f≧f0, the operation device 200 outputs the completion probability P=0 and ends the series of processes.

When the process transfers to Step S1024, the operation device 200 selects the minimum operation clock frequency f in the selectable range from the operation clock frequency f satisfying the condition of f≧f0 by the function of the power consumption calculating unit 202 (S1024). Then, the operation device 200 calculates the power quantity Qtask necessary to perform the operation task when operating at the operation clock frequency f selected in Step S1024 by the function of the power consumption calculating unit 202 (S1025). Then, the operation device 200 calculates the probability distribution p(Q) regarding the power generation quantity in the prearranged time band of performing the operation task on the basis of the weather information by the function of the probability distribution calculating unit 201 (S1026).

Then, the operation device 200 calculates the probability P of generating the power quantity equal to or more than the power consumption quantity Qtask in the period until a predetermined limit on the basis of the probability distribution p(Q) by the function of the power generation calculating unit 203 (S1027). Then, the operation device 200 outputs the probability P calculated in Step S1027 as the completion probability P by the function of the power generation calculating unit 203 (S1028), and ends the series of processes. The information of the completion probability P output by the operation device 200 is provided from the operation device 200 to the operation control device 100.

The method of calculating the completion probability according to the embodiment has been described in detail above.

1-2-3: Method of Assigning Operation Task (Method of Selecting Operation Device 200

Next, the method of assigning the operation task (the method of selecting the operation device 200) according to the embodiment will be described in detail with reference to FIG. 9 and FIG. 10. FIG. 9 and FIG. 10 are diagrams specifically illustrating the method of assigning the operation task (the method of selecting the operation device 200) according to the embodiment.

First, description will be performed with reference to FIG. 9. FIG. 9 is a diagram illustrating a process of Step S103 included in the overall flow shown in FIG. 5. The process shown in FIG. 9 is performed by the task assigning unit 103 of the operation control device 100.

As shown in FIG. 9, first, the task assigning unit 103 sets a desired value P of a probability of completing the operation task by at least one operation device 200 to the completion limit (S1031). The desired value P is different from the completion probability P provided from the operation devices 200. The completion probability P(i) provided from the i-th operation device 200 (#i) is represented by P(i), and is discriminated from the desired value P. The i-th operation device 200 (#i) is represented by an index i, a combination of n operation devices 200 (#k1 to #kn) is represented by {k1, k2, . . . , kn}.

The task assigning unit 103 setting the desired value P determines {k1, . . . , Kn} satisfying the condition shown in the following formula (3) (S1032). The probability of not completing the operation task to the completion limit by the operation device 200 (#kj) is represented by (1−P(kj)). That is, the right side of the following formula (3) means that none of n operation devices 200 (#k1 to #kn) can complete the operation task to the completion limit. That the probability is smaller than (1−P) (the condition shown in the following formula (3)) means that the probability of completing the operation task to the completion limit by at least one operation device 200 is larger than the desired value P. That is, in Step S1032, the task assigning unit 103 selects the combination of the operation devices 200 in which the probability of the completing the operation task to the completion limit by at least one operation device 200 is larger than the desired value P.

(1−P)≧(1−P(k1)) (1−P(k2)). . . (1−P(kn)) (3)

Specific Algorithm

The process in Step S1032 described above is performed by the algorithm shown in FIG. 10. As shown in FIG. 10, first, the task assigning unit 103 sorts the probabilities P(1), . . . , P(N) provided from N operation devices 200 (#1 to #N) (all the operation devices 200 which can be requested) in order of largeness (S121). The completion probabilities after the sorting are represented by P(k1), . . . , P(kN) in order of largeness. Then, the task assigning unit 103 sets initial values (Pf=1, m=0) of parameters Pf and m (S122). Then, the task assigning unit 103 increases m by 1 (S123). Then, the task assigning unit 103 calculates Pf=Pf(1−P(km)) (S124).

Then, the task assigning unit 103 determines whether or not m=N and Pf≦(1−P) (S125). When m=N or Pf≦(1−P), the task assigning unit 103 transfers the process to Step S126. Meanwhile, when m<N and PF>(1−P), the task assigning unit 103 transfers the process to Step S123. When the process transfers to Step S126, the task assigning unit 103 determines whether or not m=N and Pf>(1−P) (S126). When m=N and Pf>(1−P), the task assigning unit 103 transfers the process to Step S127. When m<N (Pf≦(1−P)), the task assigning unit 103 outputs {k1, . . . , km}, and ends the series of processes.

When the process transfers to Step S127, the task assigning unit 103 outputs or performs an exception process (S127), and ends the series of processes. As the exception process, for example, a process of designating all of N operation devices 200 (#k1 to #kN) as a request destination of the operation task is conceivable. In this case, the task assigning unit 103 selects the combination of the operation devices 200 such that the probability of completing the operation task to the completion limit by at least one operation device 200 is the maximum, although not reaching the desired value P.

The calculation control method according to the embodiment has been described above.

As described above, in the distributed processing system 10 according to the embodiment, it is possible to realize the structure in which the plurality of operation devices 200 operated using the power derived from natural energy are operated in parallel to obtain the operation result at the probability higher than the desired probability. By applying this structure, it is possible to obtain the operation result with a reliability degree equal to or larger than a predetermined value although the operation devices 200 in which the power supply is unstable are used.

### 2: Modified Example

Next, a modified example according to the embodiment will be described.

Hitherto, the case without considering the operation cost amount when selecting the operation device 200 has been described. Hereinafter, the case of considering the operation cost amount when selecting the operation device 200 will be described. The functional configuration of the operation control device 100 and the operation device 200 has been already described, and thus the functional configuration of such devices is not repeatedly described.

2-2: Operation Control Method

Hereinafter, a method of calculating a completion probability according to the modified example will be described with reference to FIG. 11 and FIG. 12. FIG. 11 and FIG. 12 are diagrams illustrating the method of calculating the completion probability according to the modified example. The method of calculating the completion probability described hereinafter is realized by the function of the operation device 200. However, if the operation control device 100 can acquire the information necessary for calculation of the completion probability such as power generation ability information and the power consumption information, the distributed processing system 10 may be configured to calculate the completion probability in the operation control device 100.

2-2-1: Overall Configuration

First, an overall flow of the process according to the operation control method of the modified example will be described with reference to FIG. 11. FIG. 11 is a diagram illustrating the overall flow of the process according to the operation control method of the modified example.

As shown in FIG. 11, first, the operation control device 100 presents the completion limit and the operation task to the plurality of operation devices 200 (#1 to #N) by the function of the operation control unit 102 (S201). The operation device 200 receiving the completion limit and the operation task calculates the completion probability and the operation cost amount, and transmits the information of the calculated completion probability and the operation cost amount to the operation control device 100 (S202). The operation control device 100 receiving the information of the completion probabilities P(1) to P(N) and the operation cost amount R(1) to R(N) from the plurality of operation devices 200 (#1 to #N) selects a combination of the operation devices 200 in which the probability (the entire completion probability) of completing the operation task by at least one operation device 200 to the completion limit is equal to or more than a predetermined value and the sum of the operation cost amount (sum cost amount) is equal to or less than a predetermined amount by the task assigning unit 103 (S203).

For example, the task assigning unit 103 extracts combinations of the operation devices 200 in which the entire completion probability is equal to or lower than a predetermined value, and selects a combination in which the sum cost amount is the minimum is selected from the extracted combinations. The task assigning unit 103 may extract combinations of the operation devices 200 in which the sum cost amount is equal to or less than a predetermined amount, and may select a combination in which the entire completion probability is the maximum from the extracted combinations. When the combination of the operation devices 200 requested for the operation task is selected, the task assigning unit 103 assigns the operation task to the selected operation device 200. Then, the operation control device 100 requests the operation device 200 assigning the operation task, for the operation task by the function of the operation control unit 102 (S204).

The overall flow of the process according to the operation control method of the modified example has been described above.

2-2-2: Method of Assigning Operation Task (Method of Selecting Operation Device 200)

Next, the method of assigning the operation task (the method of selecting the operation device 200) according to the modified example will be described with reference to FIG. 12. FIG. 12 is a diagram illustrating the method of assigning the operation task (the method of selecting the operation device 200) according to the modified example.

As shown in FIG. 12, first, the task assigning unit 103 sets a desired value P of a probability of completing the operation task by at least one operation device 200 to the completion limit (S2031). The desired value P is different from the completion probability P provided from the operation devices 200. The completion probability P(i) provided from the i-th operation device (#i) is represented by P(i), and is discriminated from the desired value P. The i-th operation device 200 (#i) is represented by an index i, a combination of n operation devices 200 (#k1 to #kn) is represented by {k1, k2, . . . , kn}. Then, the task assigning unit 103 sets an upper limit value R of the desired sum cost amount (S2032).

The task assigning unit 103 setting the desired value P and the upper limit value R of the sum cost amount determines {k1, . . . , kn} satisfying the condition shown in the following formulas (4) and (5) (S2033). However, it is difficult to determine the optimal {k1, . . . , kn} satisfying all the conditions shown in the following formulas (4) and (5). In the case of emphasizing the cost, the combinations of {k1, . . . , kn} satisfying the following formula (4) may be extracted, and it is preferable to select {k1, . . . , kn} in which the right side of the following formula (5) is the minimum from the combinations. In the case of emphasizing the probability, the combinations of {k1, . . . , kn} satisfying the following formula (5) may be extracted, and it is preferable to select the combination of {k1, . . . , kn} in which the right side of the following formula (4) is the minimum from among the combinations.

(1−P)≧(1−P(k1)) (1−P(k2)). . . (1−P(kn)) (4)

R≧R(k1)+R(k2)+. . . +R(kn) (5)

The method of assigning the operation task (the method of selecting the operation device 200) according to the modified example has been described above.

As described above, in the distributed processing system 10 according to the modified example, it is possible to realize the structure in which the plurality of operation devices 200 operated using the power derived from natural energy are operated in parallel to obtain the operation result at the probability higher than the desired probability and the cost equal to or less than the desired cost. By applying this structure, it is possible to obtain the operation result with a reliability degree equal to or larger than a predetermined value and a low cost, using the operation devices 200 in which the power supply is unstable.

### 3: Example of Hardware Configuration

The functions of the constituent elements of the operation control device 100 and the operation device 200 may be realized, for example, using the hardware configuration of the information processing device shown in FIG. 13. That is, the functions of the constituent elements are realized by controlling the hardware shown in FIG. 13 using a computer program. The type of the hardware is arbitrary, and includes, for example, a personal computer, a mobile phone, a PHS, a mobile information terminal such as a PDA, a game device, and various information home appliances. The PHS is an abbreviation for Personal Handy-phone System. The PDA is an abbreviation for Personal Digital Assistant.

As shown in FIG. 13, the hardware mainly includes a CPU 902, a ROM 904, a RAM 906, a host bus 908, and a bridge 910. The hardware includes an external bus 912, an interface 914, an input unit 916, an output unit 918, a storage unit 920, a drive 922, a connection port 924, and a communication unit 926. CPU is an abbreviation for Central Processing Unit. ROM is an abbreviation for Read Only Memory. RAM is an abbreviation for Random Access Memory.

For example, the CPU 902 serves as the operation processing device or the control device, and controls all or a part of the operations of the constituent elements on the basis of various programs recorded in the ROM 904, the RAM 906, the storage unit 920, or the removable recording medium 928. The ROM 904 is a unit storing programs read by the CPU 902 and data used for the calculation. In the RAM 906, for example, the program read by the CPU 902 and various parameters appropriately changed when performing the program are temporarily or permanently stored.

For example, such constituent elements are connected to each other through the host bus 908 capable of transmitting data at high speed. For example, the host bus 908 is connected to the external bus 912 of a relatively low speed of data transmission through the bridge 910. As the input unit 916, for example, a mouse, a keyboard, a touch panel, a button, a switch, a lever, and the like are used. In addition, as the input unit 916, a remote controller capable of transmitting a control signal using infrared rays or other electronic waves may be used.

The output unit 918 is, for example, a display device such as a CRT, an LCD, a PDP, and an ELD, an audio output device such as a speaker and a headphone, and a device capable of visually and auditorily notifying a user of the acquired information such as a printer, a mobile phone, and a facsimile. CRT is an abbreviation for Cathode Ray Tube. LCD is an abbreviation for Liquid Crystal Display. The PDP is an abbreviation for Plasma Display Panel. ELD is an abbreviation for Electro-Luminescence Display.

The storage unit 920 is a device for storing various kinds of data. As the storage unit 920, for example, a magnetic storage device such as a hard disk drive (HDD), a semiconductor storage device, an optical storage device, or an optical magnetic device is used. HDD is an abbreviation for Hard Disk Drive.

The drive 922 is, for example, a device of reading information recorded in the removable recording medium 928 such as a magnetic disk, an optical disc, an optical magnetic disc, and a semiconductor memory, or writing information in the removable recording medium 928. The removable recording medium 928 is, for example, a DVD media, a Blu-ray media, an HD DVD media, and various semiconductor storage devices. Of course, the removable recording medium 928 may be, for example, an IC card provided with a non-contact type IC chip or an electronic device. IC is an abbreviation for Integrated Circuit.

The connection port 924 is, for example, a port for connecting to an external connection device 930 such as a USB port, an IEEE1394 port, an SCSI, an RS-232C port, and an optical audio terminal. The external connection device 930 is, for example, a printer, a mobile music player, a digital camera, a digital video camera, and an IC recorder. USB is an abbreviation for Universal Serial Bus. SCSI is an abbreviation for Small Computer System Interface.

The communication unit 926 is a communication device for connecting to the network 932, and is, for example, a wire or wireless LAN, a Bluetooth (registered trademark), a WUSB communication card, an optical communication router, an ADSL router, or various communication modems. The network 932 connected to the communication unit 926 is configured by a network connected by wire or wireless, and is, for example, the Internet, a home LAN, infrared communication, visible ray communication, broadcasting, and satellite communication. LAN is an abbreviation for Local Area Network. WUSB is an abbreviation for Wireless USB. ADSL is an abbreviation for Asymmetric Digital Subscriber Line.

### 4: Conclusion

Finally, the technique according to the embodiment of the present disclosure will be briefly summarized. The technique described herein may be applied to various information processing devices such as a PC, a mobile phone, a mobile game device, a mobile information terminal, an information home appliance, and a car navigation system. For example, the functions of the operation control device and the operation devices constituting the distributed processing system to be described below may be realized by the information processing device described above.

The embodiment of the present disclosure relates to the configuration of the following distributed processing system. The distributed processing system is mainly configured by the following plurality of operation devices and operation control device. The operation devices perform the operation using the power derived from natural energy. The operation control device has the following task assigning unit and the operation control unit. The task assigning unit assigns the same operation task to the plurality of operation devices. The operation control unit controls the plurality of operation devices to perform the operation task assigned by the task assigning unit.

As described above, the supply amount of power derived from natural energy is unstable. When a shortage of the power supply occurs, the operation device interrupts the operation or performs the operation with low operation performance to reduce the power consumption. For this reason, a long time is taken until the completion of the operation, as compared with the case of performing the operation in a state of stably supplying power. As a result, the operation may not be completed before the desired completion time. In addition, it is not easy to predict the timing of short power supply or the shortage amount since the supply source of power is natural energy. For this reason, the operation control device assigns the same operation task to the plurality of operation devices, and performs the operation task in parallel.

When the same operation task is performed by the plurality of operation devices, it is possible to achieve the purpose when the operation is completed to the desired time in at least one operation device. That is, even when the probability of completing the operation until the desired time by each operation device is low, it is possible to raise the probability of completing the operation to the desired time by at least one operation device by using the plurality of operation devices together. For example, when the operation is performed using the power with unstable supply amount and low power generation cost, it is possible to decrease the operation cost. For this reason, when the plurality of operation devices performing the operation using the power with the low power generation cost is used, it is possible to complete the operation with a relatively low operation cost. By adjusting balance between the number of used operation devices and the stability of the power supply, it is possible to obtain the desired reliability with the desired operation cost.

Note

The task assigning unit 103 is an example of the cost acquiring unit. The probability distribution calculating unit 201 and the power consumption calculating unit 202 is an example of the task information acquiring unit. The probability distribution calculating unit 201 is an example of the weather information acquiring unit and the distribution calculating unit. The power generation probability calculating unit 203 is an example of the completion probability calculating unit.

The present disclosure contains subject matter related to that disclosed in Japanese Priority Patent Application JP 2010-275975 filed in the Japan Patent Office on Dece. 10, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A distributed processing system comprising:
a plurality of operation devices that perform an operation using power derived from natural energy; and
an operation control device that includes a task assigning unit that assigns the same operation task to the plurality of operation devices, and an operation control unit that controls the plurality of operation devices to perform the operation task assigned by the task assigning unit.

2. The distributed processing system according to claim 1, wherein each operation device includes a probability calculating unit that calculates a probability of completing the operation task within a predetermined period on the basis of weather information, and wherein the task assigning unit extracts a combination of the operation devices in which the probability of completing the operation task within the predetermined period by at least one operation device is equal to or more than a predetermined value on the basis of the probability calculated by the probability calculating unit of each operation device, and assigns the operation task to the plurality of extracted operation devices.

3. The distributed processing system according to claim 2, further comprising a cost acquiring unit that acquires an amount of payable costs when the operation task is performed in the operation devices,
wherein when there are a plurality of combinations of the operation devices, the task assigning unit selects a combination of the operation devices in which the sum of costs acquired by the cost acquiring unit is the minimum, and assigns the operation task to the plurality of selected operation devices.

4. The distributed processing system according to claim 1, wherein each operation device further includes a probability calculating unit that calculates a probability of completing the operation task within a predetermined period on the basis of weather information,
wherein the operation control device further includes a cost acquiring unit that acquires an amount of payable costs when the operation task is performed in the operation devices, and
wherein the task assigning unit extracts combinations in which the sum of costs acquired by the cost acquiring unit is equal to less then a predetermined amount, selects a combination of the operation devices in which the probability of completing the operation task within the predetermined period by at least one operation device is the minimum from the extracted combinations of the operation devices on the basis of the probability calculated by the probability calculating unit, and assigns the task to the plurality of selected operation devices.

5. The distributed processing system according to claim 2, wherein the probability calculating unit includes a probability distribution calculating unit that is connected to the operation device and calculates a distribution p(Q) of probabilities of generating a power quantity Q within the predetermined period by a natural energy generator supplying the power derived from the natural energy to the operation device on the basis of the weather information, a power consumption calculating unit that calculates a power quantity Qc consumed when the operation device performs the operation task, and a power generation probability calculating unit that calculates a probability P of generating power equal to or more than the power quantity Qc calculated by the power consumption calculating unit by the natural energy generator within the predetermined period on the basis of the distribution p(Q) of the probabilities calculated by the probability distribution calculating unit, and
wherein each operation device reports the probability P calculated by the power generation probability calculating unit to the operation control device, as the probability of completing the operation task within the predetermined period by the operation device.

6. The distributed processing system according to claim 5, wherein when a storage battery with a storage quantity Qb is connected to the operation device, the power generation probability calculating unit calculates a probability P of generating power equal to more than power quantity (Qc−Qb) obtained by subtracting the storage quantity Qb from the power quantity Qc by the natural energy generator within the predetermined period, on the basis of the distribution P(Q) of the probabilities calculated by the probability distribution calculating unit.

7. An operation device comprising:
a power receiving unit that receives power supplied from a generator generating power using natural energy;
a task information acquiring unit that acquires information related to an operation task and information related to a completion limit of the operation task;
a weather information acquiring unit that acquires weather information within a period until the completion limit of the operation task acquired by the task information acquiring unit;
a distribution calculating unit that calculates probability distribution of the power quantity supplied to the power receiving unit within the period until the completion limit of the operation task on the basis of the weather information acquired by the weather information acquiring unit;
a power consumption calculating unit calculates a power quantity necessary to perform the operation task on the basis of the information related to the operation task acquired by the task information acquiring unit; and
a completion probability calculating unit that calculates a probability of completing the operation task within the period until the completion limit of the operation task on the basis of the probability distribution of the power quantity calculated by the distribution calculating unit and the power quantity calculated by the power consumption calculating unit.

8. An operation control unit comprising:
a task assigning unit that assigns the same operation task to a plurality of operation devices performing an operation using power derived from natural energy; and
an operation control unit that controls the plurality of operation devices to perform the operation task assigned by the task assigning unit.

9. An operation control method comprising:
assigning the same operation task to a plurality of operation devices performing an operation using power derived from natural energy; and
controlling the plurality of operation devices to perform the operation task assigned by the task assigning unit.

10. A method of calculating a completion probability of an operation task in an operation device having a power receiving unit receiving power supplied from a power generator generating power using natural energy, the method comprising:
acquiring information related to an operation task and information related to a completion limit of the operation task;
acquiring weather information within the period until the completion limit of the operation task acquired in the acquiring of the task information;
calculating probability distribution of the power quantity supplied to the power receiving unit within the period until the completion limit of the operation task on the basis of the weather information acquired in the acquiring of the weather information;
calculating a power quantity necessary to perform the operation task on the basis of the information related to the operation task acquired in the acquiring of the task information; and
calculating a probability of completing the operation task within the period until the completion limit of the operation task on the basis of the probability distribution of the power quantity calculated in the calculating of the distribution and the power quantity calculated in the calculating of the power consumption.

11. A program for causing a computer to execute:
a task assigning a function of assigning the same operation task to a plurality of operation devices performing an operation using power derived from natural energy; and
an operation control function of controlling the plurality of operation devices to perform the operation task assigned by the task assigning function.

12. A program for causing a computer having a power receiving unit that receives power supplied from a generator generating power using natural energy to execute:
a task information acquiring function of acquiring information related to an operation task and information related to a completion limit of the operation task;
a weather information acquiring function of acquiring weather information within the period until the completion limit of the operation task acquired by the task information acquiring function;
a distribution calculating function of calculating probability distribution of the power quantity supplied to the power receiving unit within the period until the completion limit of the operation task on the basis of the weather information acquired by the weather information acquiring function;
a power consumption calculating function of calculating a power quantity necessary to perform the operation task on the basis of the information related to the operation task acquired by the task information acquiring function; and
a completion probability calculating function of calculating a probability of completing the operation task within the period until the completion limit of the operation task on the basis of the probability distribution of the power quantity calculated by the distribution calculating function and the power quantity calculated by the power consumption calculating function.
